(19) United States
(12) Patent Application Publication
(10) Pub. No.: US 2011/0245522 A1
(43) Pub. Date: Oct. 6, 2011

(54) Method of Fabricating Fatty Acid Methyl Ester by Using Bronsted Acid Ionic Liquid

(75) Inventors: Jung-Chung Wu, Chiayi City (TW); Ming-Yu Huang, Chiayi City (TW); Jen-Chun Chang, Chiayi City (TW); Jann-Chen Lin, Chiayi City (TW); Kuen-Hai Lin, Chiayi City (TW)

(73) Assignee: CPC CORPORATION, TAIWAN, Taipei (TW)

(21) Appl. No.: 12/754,859

(22) Filed: Apr. 6, 2010

(51) Int. Cl. C11C 3/00

(52) U.S. Cl. 554/161

(57) ABSTRACT

A new method for fabricating fatty acid methyl ester (FAME) is provided. A Bronsted acid ionic liquid is used. After some reactions, two layers of materials are formed. A product of FAME is obtained at the upper layer of material. The lower layer of material is the ionic liquid. Thus, the ionic liquid is reusable for re-fabricating the FAME product. And, furthermore, waste acid is thus reduced.

### TECHNICAL FIELD OF THE DISCLOSURE

The present disclosure relates to fabricating fatty acid methyl ester (FAME); more particularly, relates to using a Bronsted acid IL as a catalyst for fabricating FAME by separating product and catalyst in two layers with catalyst recycled and reused and waste acid reduced.

### DESCRIPTION OF THE RELATED ARTS

Palm oil used in oil and fat chemical industry is usually purified through centrifugal separation to obtain crude palm oil (CPO) while 5% of palm fatty acid distillate (PFAD) is separated. The PFAD contains linoleic acid, oleic acid, stearic acid, palmitic acid, and myristic acid. For recycling the fatty acid in it, a catalytic reaction is processed to obtain liquid fuel (gasoline or biodiesel) or chemical product, although the procedure is difficult and not economical. For example, by using H-ZSM-5 as a catalyst, PFAD is cracked into hydrocarbon components under 400˜450° C. with a 44% yield.

In addition, the most used procedure to produce a biodiesel in industry is a glyceride transesterification by an alkali catalyst and has a faster conversion rate than that using acid catalyst. But the feeds, glyceride and methanol, are almost waterless (<0.06 wt %) and have a low free fatty acid (<0.5 wt %) because the saponification reaction could be generated as well as reducing the activity of transesterification and the insoluble soap byproducts increase the difficulty of separating product from the catalyst. Hence, the inputs have to be preprocessed where FFA are reacted with methanol for generating fatty acid methyl esters (FAME) by an acid catalyst, followed with the removal of water, and then been put into the alkali process for transesterification. Combined with the two processes, the efficiency of producing biodiesel is improved.

Esterification with fatty acid and alcohol uses liquid acid as catalyst, like sulfuric acid (H₂SO₄), hydrofluoric acid (HF), or p-toluenesulfonic acid (P-TSA). Although esterification is thus effectively processed, waste acid problem remains. Solid acid is one of the solutions, like Amberlyst 15 (ion exchange resin) and Nafion NR-50; yet, its thermal tolerance is below 150° C. with limited applications. Inorganic solid acid, like zeolite, can be operated under a higher temperature with adjustable acidity. Yet, for bigger reacting molecules, pores are too small for mass transfer effect and thus reactions are happened only on surface with a low rate. Even by using a zeolite having bigger pores, side reaction may happen owing to high temperature. For a molecular sieve having middle-size pores, like MCM-41, it is mainly constructed with silicon dioxide (SiO₂) without enough acidity for esterification. At this moment, an element like Al, Zr or Ti may be added to increase acidity; but the acidity is still too low for high esterification. Or, heteropoly acid (HPA) may be applied on surface of MCM-41 for esterification with n-butanol and acetic acid, whose conversion rate reaches to 95% under 110° C. and is higher than that without HPA. Yet, water generated from the reaction will make HPA move to outer surface and activity of the catalyst is thus reduced. Sulphate ion/zirconium dioxide (SO₄²⁻/ZrO₂) has a strong acidity to be used for esterification; yet, H₂SO₄ and hydrogensulphate (HSO₄⁻) may be easily generated and thus sulfate may be run off. Alternatively, a precursor of chlorosulfonic acid may be used to be dissolved in an organic solution for obtaining a highly active catalyst with no sulfate run off. Or, SO₄²⁻/SnO₂ may be used, which has a higher activity than SO₄²⁻/ZrO₂. Or, a solid acid called Nafion SAC-13 may be applied in an esterification with acetic acid and alcohol. Although the above solid catalysts are better than the liquid catalysts in some way, bigger molecules may not be easily attached to the acidic site and the activity decay is serious.

Bronsted acid ionic liquid (IL) with SO₃⁻ or HSO₄⁻ anion are waterproof and are used in many kinds of esterifications. Yoshizawa etc. revealed a fabrication method of Bronsted acid IL in 2001, where N-butyl imidazole or triphenylphosphine is reacted with 1,4-butane or 1,3-propane sultone to obtain zwitterion; and then is purified to be reacted with an acid like H₂SO₄, CF₃SO₃H or p-CH₃—C₆H₄—SO₃H to obtain an apparent Bronsted acid IL [J. Mater. Chem., 11, 1059 (2001)]. Forbes' laboratory used a Bronsted acid IL of imidazole or triphenylphosphine containing—SO₃H anion for catalyzing esterification of ethanol/(acetic acid) with a yield of 96% [J. Am. Chem. Soc., 124, 5962 (2002)]]. Xing etc. used N-propyl sulf one pyridinium (PSPy) to fabricate a Bronsted acid IL for esterification of (benzoic acid)/alcohol [Ind. Eng. Chem. Res., 44, 4147 (2005)]. Liang etc. used 1-butyl-3-methyl imidazolium (BMIM) with HSO₄⁻ or H₂PO₄⁻ to fabricate a Bronsted acid IL for catalyzing esterification of salicylic acid and acetic anhydride and obtaining aspirin with a yield of 63% [Chin. J. Appl. Chem., 24(9), 1080 (2007)]. Although Bronsted acid ILs are used in esterification reactions, none is revealed for synthesizing fatty acid methyl ester (FAME) used in biodiesel.

Hence, the prior arts do not fulfill all users' requests on actual use.

### SUMMARY OF THE DISCLOSURE

The main purpose of the present disclosure is to use a Bronsted acid IL as a catalyst for fabricating FAME by separating product and catalyst in two layers with catalyst recycled and reused and waste acid reduced.

To achieve the above purpose, the present disclosure is a method of fabricating FAME by using Bronsted acid IL, comprising steps of: (a) reacting an organic nitride compound with alkyl sultone to obtain a solid of zwitterion and, after drying and purifying the zwitterion, processing a reaction with a strong acid containing sulfonic group (—SO₃H) to obtain a dense waterproof acidic IL; (b) adding a hot solution of methanol and fatty acid into the IL to process an esterification; and (c) staying still at a high temperature to obtain two layers of materials spontaneously where a product is obtained in the upper layer and the lower layer is the IL. In addition, the lower IL catalyst could be vacuumed to remove the unreacted methanol and water generated from esterification and reused by recharging with fresh reactants. Accordingly, a novel method of fabricating FAME by using Bronsted acid IL is obtained.

### BRIEF DESCRIPTIONS OF THE DRAWINGS

The present disclosure will be better understood from the following detailed description of the preferred embodiment according to the present disclosure, taken in conjunction with the accompanying drawings, in which

FIG. 1 is the flow view showing the preferred embodiment according to the present disclosure;

FIG. 2 is the view showing the formulas for fabricating the acidic IL;

FIG. 3 is the view showing the conversion rates for different temperatures;

FIG. 4 is the view showing the conversion rates for different reaction periods of time;

FIG. 5 is the view showing the conversion rates for different mole ratios of CH₃OH/FFA;

FIG. 6 is the view showing the conversion rates for different ILs;

FIG. 7 is the view showing the conversion rates for different amounts of IL;

FIG. 8 is the view showing the conversion rates for different recycle times of acidic IL; and

FIG. 9 is the view showing the equipments of the preferred embodiment.

### DESCRIPTION OF THE PREFERRED EMBODIMENT

The following description of the preferred embodiment is provided to understand the features and the structures of the present disclosure.

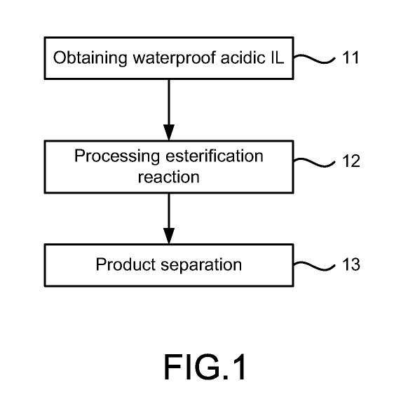

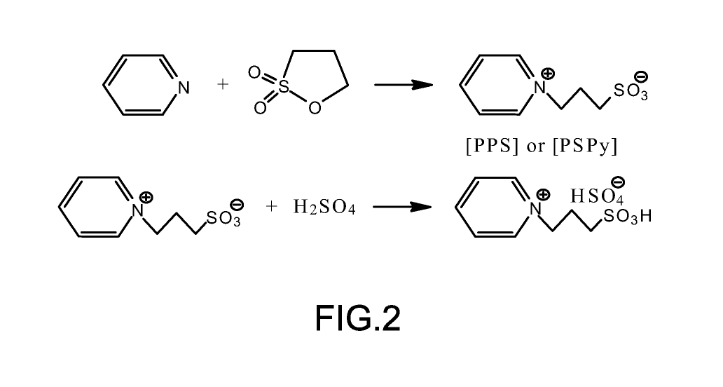

Please refer to FIG. 1 and FIG. 2, which are a flow view showing a preferred embodiment according to the present disclosure; and a view showing formulas for fabricating the acidic ionic liquid (IL). As shown in the figures, the present disclosure is a method of fabricating fatty acid methyl ester by using Bronsted acid IL. The present disclosure uses a Bronsted acid IL as a catalyst for fabricating fatty acid methyl ester (FAME), comprising the following steps:

(a) Obtaining waterproof acidic IL 11: Firstly, an organic nitride compound, like imidazole, pyridine or trialkylamine, is reacted with alkyl sultone, like 1,3-propyl or 1,4-butyl sultone, to obtain a white zwitterion solid. Then, the solid is purified and dried with ether and then reacted with a Bronsted strong acid, like a sulfuric acid (H₂SO₄, SA) or a sulfonic acid (R—SO₃H), where the sulfonic acid can be fluorosulfonic acid (FSO₃H, FS), trifluoromethanesulfonic acid (CF₃SO₃H, TFMSA) or p-toluenesulfonic acid (p-CH₃—C₆H₄—SO₃H, P-TSA). The mixture is stirred under 80° C. for 6 hours to obtain a dense waterproof acidic IL—a Bronsted acid IL. Therein, a mole ratio of the strong acid to the zwitterion solid is between 1.0 and 1.5—between 1.0 and 1.2 is preferred.

(b) Processing esterification reaction 12: A hot methanol and fatty acid solution is added to the IL for esterification, where a mole ratio of the IL to the fatty acid is between 0.01 and 1.0; a mole ratio of methanol to the fatty acid is between 1 and 30; the esterification is processed at a temperature between 25° C. and 120° C. for a period between 0.1 and 10 hours; and a high-temperature reaction is processed in a methanol reflux system or a closed system.

(c) Product separation 13: After the above reaction, two layers of materials are formed. The upper layer is a product and the lower layer is the IL, where the product is thus easily taken out. Then, a vacuum heating system was applied for removing methanol and water; thus, the lower layer of IL can be reused for next esterification.

In this way, product is separated from acid catalyst in two layers for reusing the catalyst easily; and, a green catalytic procedure with reduced catalyst waste is thus obtained.

The present disclosure used a Bronsted acid IL to process an esterification of a fatty acid for producing biodiesel effectively, where the fatty acid is a fatty acid distillate formed during separating fatty acids in oleic acid chemical industries. The fatty acid used in the present disclosure has an acid value of 189, whose components includes 4% of myristic acid (C14:0), 48% of palmitic acid (C16:0), 4% of stearic acid (C18:0), 36% of oleic acid (C18:1) and 8% of linoleic acid (C18:2) with a structure as follows:

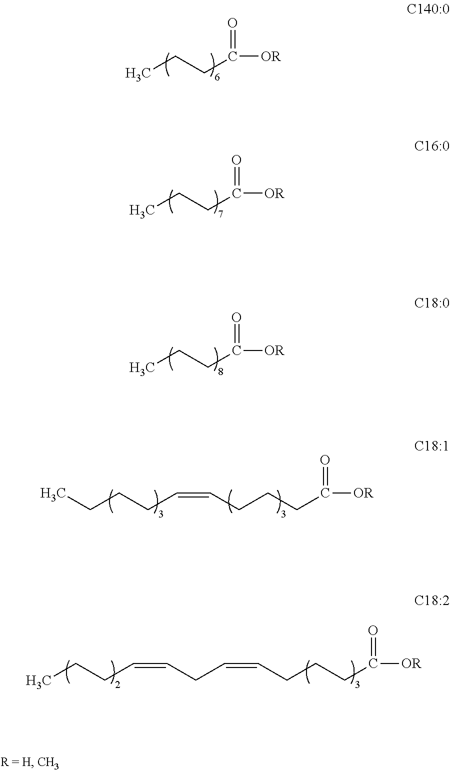

Therein, the palmitic acid and the stearic acid are fatty acids in solid form under ordinary temperature; and, the oleic acid and the linoleic acid are respectively a monoolefin fatty acid and a diolefin fatty acid in liquid form under ordinary temperature. Hence, the fatty acid distillate has a yellow solid form under ordinary temperature and has to be dissolved into methanol solution by heating on processing the reaction, whose reaction formula is as follows:

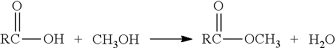

Therein, R is an alkyl or olefin group with a structure of CₙH₂ₙ₊₁ or CₙH₂ₙ₋₁, where n=14˜18.

The present disclosure uses a Bronsted acid IL for esterification to obtain an esterified product, where the IL is reusable for next esterification after removing methanol and water.

The acidic IL used in the present disclosure is obtained by reacting sulfonic-containing zwitterion with H₂SO₄, CF₃SO₃H, FSO₃H or p-CH₃—C₆H₄—SO₃H, where HSO₄⁻, CF₃SO₃⁻, FSO₃⁻ or p-CH₃—C₆H₄—SO₃⁻ is cation. The zwitterion is used as a precursor of the acidic IL; and is obtained by reacting an organic nitride compound with alkyl sultone, where the nitride compound is an imidazole compound, a pyridine compound or an alkylamine compound. The zwitterion has the following structure:

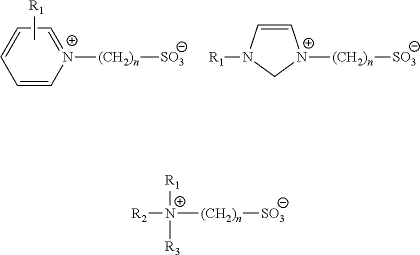

Therein, n=3˜6 and R₁, R₂ and R₃ are alkyl with a structure of CₘH₂ₘ₊₁ where m=1˜18.

On fabricating the acidic IL, at first, for example pyridine or imidazole is reacted with 1,3-propane sultone under 40° C. for 24 hours to obtain a white solid zwitterion. After being purified with ether and dried in vacuum, R⁺—(CH₂)₃—SO₃⁻ is obtained. As if R is pyridine, n-propane sulfonic acid pyridinium (PSPy; or, pyridinium propyl sulfobetaine, PPS) is obtained. The acidic IL was prepared by adding a few moles of H₂SO₄ to the white PSPy solid and being stirred under 80° C. for 4 hours. Then, IL materials are washed out with toluene and ether and vacuum drying is processed to obtain [R⁺—(CH₂)₃—SO₃H][HSO₄⁻].

Then, a hot solution with fatty acid distillate (free fatty acid, FFA) dissolved in a certain amount of methanol is poured into the dense IL for reaction by heating with 400 rpm of stirring. After the reaction, layers are formed by staying still and upper layer is taken out as product for analysis through gas chromatography (GC) to measure a fatty acid conversion rate, an ester content yield and an acid value and to measure contents of sulphur and water. Therein, the reaction is processed at a temperature between 40° C. and 80° C. for a period of time between 1 and 6 hours with a mole ratio of CH₃OH/Fatty acid between 3 and 10 and a mole ratio of IL/FFA between 0.1 and 0.4. A pyridine-type IL with HSO₄⁻, CF₃SO₃⁻, FSO₃— or p-CH₃—C₆H₄—SO₃ anion is measured; an imidazole-type IL (1-butyl-3-methyl imidazolium hydrogen sulfate, [BMIM][HSO₄⁻] or [BMIM][HS]) is also measured. After the reaction, the lower IL layer is vacuumed under 80° C. for removing extra methanol and water. The methanol is recycled and new feeds are added for reaction.

### State-of-Use 1: Various Temperatures

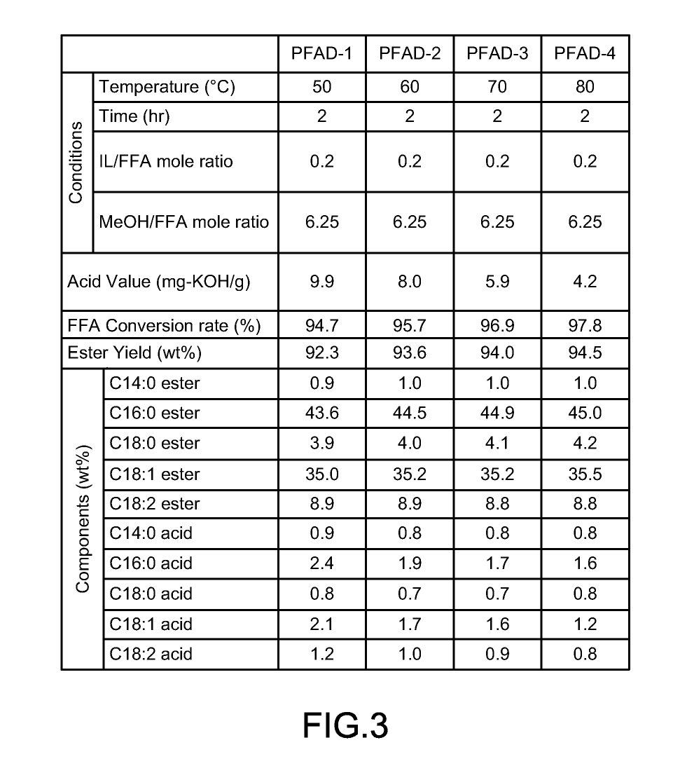

Please refer to FIG. 3, which is a view showing conversion rates for different temperatures. As shown in the figure, 2.02 g (0.01 mole) of PSPy solid is put in a bottle and 0.98 g (0.01 mole) of H₂SO₄ is gradually added to be stirred under 60° C. for 30 minutes to obtain a dense IL. Then 14.1 g (0.05 mole) of FFA is dissolved in a hot solution of 10 g (0.312 mole) CH₃OH. Then the IL and the solution are mixed to be stirred for reaction at 400 rpm for 2 hours. After reaction, it is stayed still to obtain two layers—the upper layer is an ester product and the lower layer is an IL dissolved with methanol and water. The product is taken out to be analyzed through GC for obtaining its components (FFA and FAME) and acid value, where a conversion rate is expressed through a change in the acid value. As results show, increased FFA conversion rates and increased ester yields are obtained with increased temperatures—the acid value is ranged from 9.9 to 4.2. Therein, under a 6.25 mole ratio of CH₃OH/FFA and a 0.2 mole ratio of IL/FFA, a preferred temperature for reaction is between 60° C. and 80° C.

### State-of-Use 2: Various Reaction Periods of Time

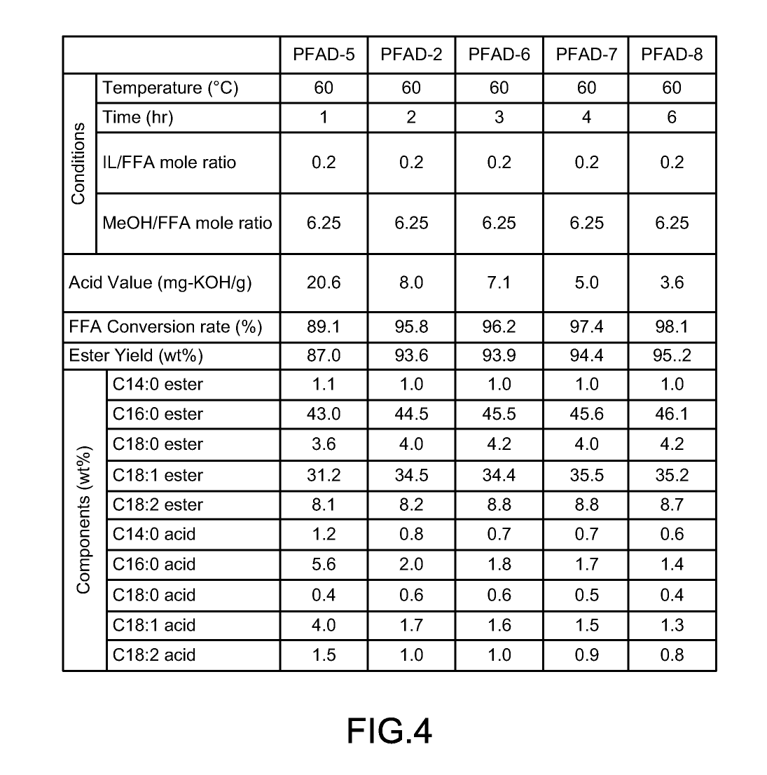

Please refer to FIG. 4, which is a view showing conversion rates for different reaction periods of time. As shown in the figure, through the same process used in State-of-use 1, the reactions are processed under 60° C. for 1, 2, 3, 4 and 6 hours. As results show, with increased reaction period of time, conversion rate is increased from 89.1% for 1 hour to 98.1% for 6 hours and FAME content is increased from 87.0% to 95.2%-2 to 3 hours of reaction time is preferred.

### State-of-Use 3: Various Mole Ratios of CH₃OH/FFA

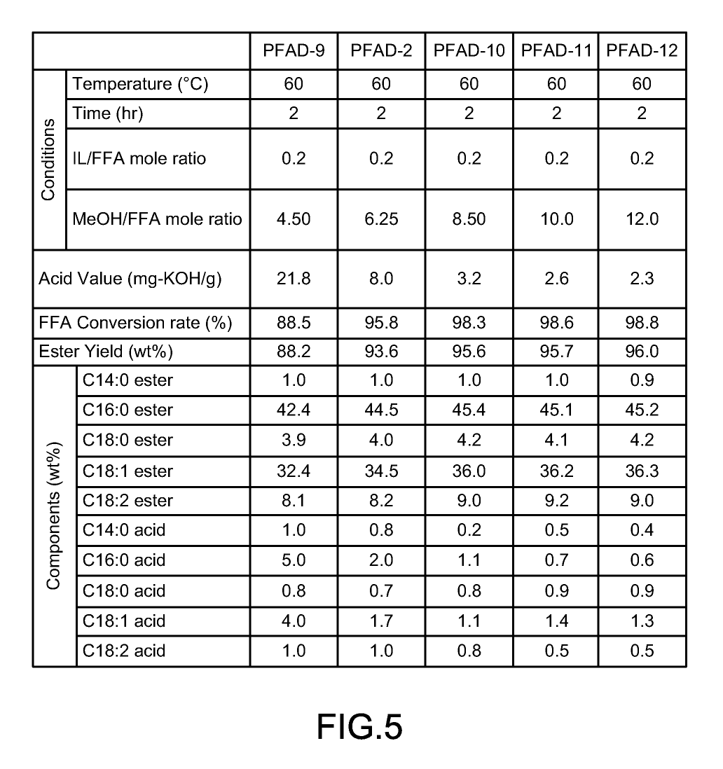

Please refer to FIG. 5, which is a view showing conversion rates for different mole ratios of CH₃OH/FFA. As shown in the figure, through the same process used in State-of-use 1, the reaction is processed for 2 hours with different mole ratios of CH₃OH/FFA, which are 4.50, 6.25, 8.50, 10.0 and 12.0. As results show, with increased mole ratios of CH₃OH/FFA, conversion rates are increased from 88.5% for 4.50 mole ratio to 98.8% for 12.0 mole ratio. Since a higher mole ratio results in a great amount of methanol to be recycled, a preferred mole ratio of CH₃OH/FFA is between 6 and 10.

### State-of-Use 4: Various Acids and Positive Ions

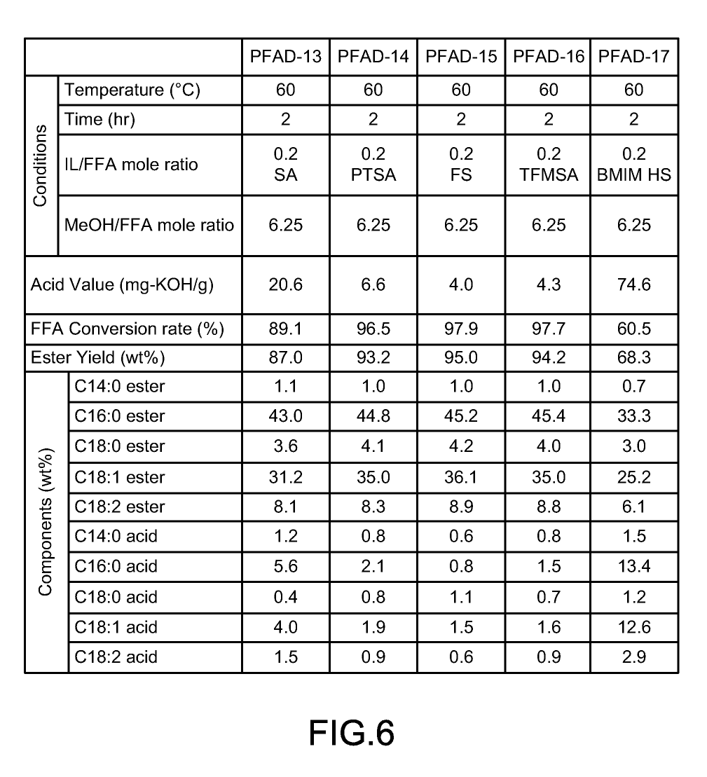

Please refer to FIG. 6, which is a view showing conversion rates for different ILs. As shown in the figure, through the same process used in State-of-use 1, the reaction is processed under 60° C. for 2 hours at a 6.25 mole ratio of CH₃OH/FFA with various acids, including H₂SO₄ (SA), p-toluenesulfonic acid (PTSA), fluorosulfonic acid (FS), trifluoromethanesulfonic acid (TFMSA) and imidazole-type IL ([BMIM][HS]). As results show, conversion rates are ranged as follows: [PSPy][FS]>[PSPy][TFMSA]>[PSPy][PTSA]>[PSPy][SA]>[BMIM][HS], which are conformed to their acidities. The low conversion rate for [BMIM] is owing to its lack of —SO₃H.

### State-of-Use 5: Various Amounts of IL

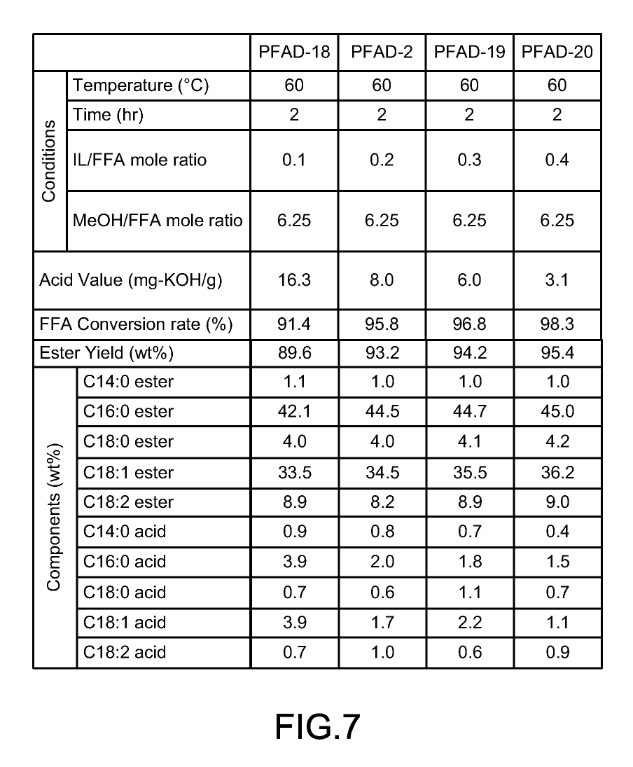

Please refer to FIG. 7, which is a view showing conversion rates for different amounts of IL. As shown in the figure, through the same process used in State-of-use 1, the reaction is processed under 60° C. for 2 hours with a 6.25 mole ratio of CH₃OH/FFA and with different amounts of [PSPy][SA] IL, whose mole ratios of IL/FFA are 0.1, 0.2, 0.3 and 0.4. As results show, with the mole ratio of IL/FFA increased from 0.1 to 0.4, the conversion rate is increased from 91.4% to 98.3%.

### State-of-Use 6: Reused IL

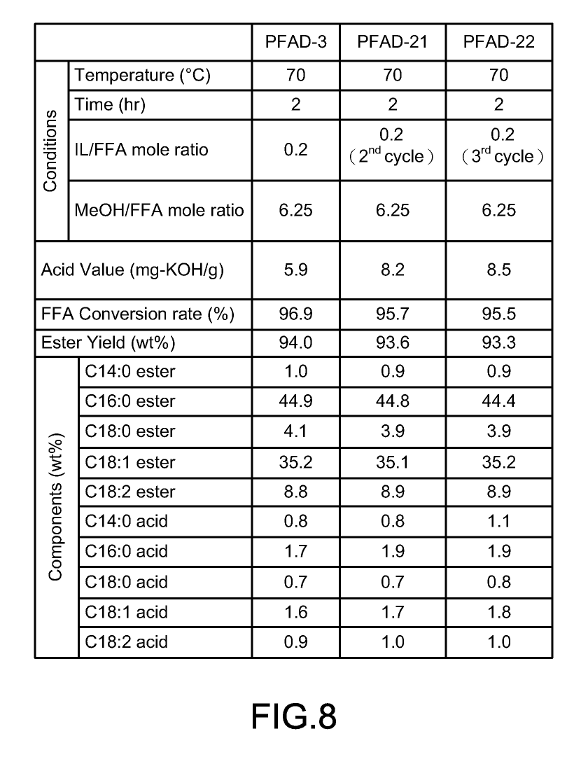

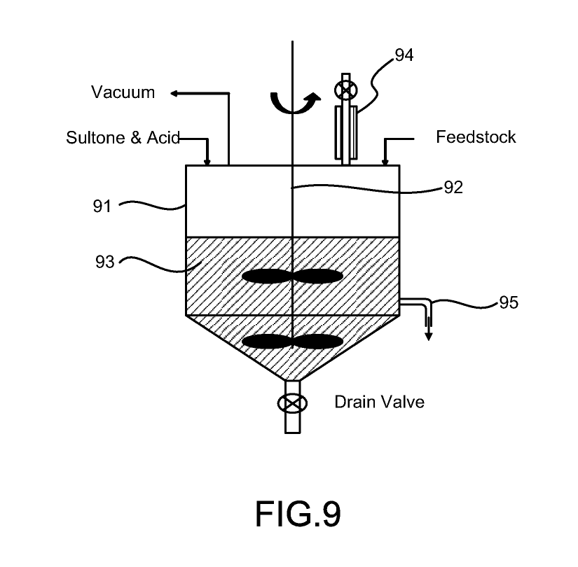

Please refer to FIG. 8 and FIG. 9, which are a view showing conversion rates for different reused acidic IL; and a view showing equipments of the preferred embodiment. As shown in the figures, through the same process used in State-of-use 1, the reaction is processed under 70° C. for 2 hours with a catalyst of [PSPy][SA], where mole ratios of IL/FFA and CH₃OH/FFA are 0.2 and 6.25 respectively. After reaction, two layers are formed by staying still. The upper layer of product is taken out and the lower layer of IL is heated under 80° C. for removing methanol and water to be recycled for next reaction. As results show, after being recycled for two times, the activity remains high above 98%. At first, the zwitterion and the strong acid is added into a reactor 91 with a stirring part to be mixed at a temperature between 70° C. and 80° C. for obtaining a dense IL 93. Then, a hot solution of CH₃OH/FFA is added to be stirred under a temperature between 70° C. and 80° C. for 2 hours. And, then, the reactor 91 is vacuumed for recycling extra methanol and removing the water generated. Then, it is stayed still for forming two layers. The upper layer of product is taken out from a reactor side pipe 94 and the lower layer of IL is reused for next reaction.

To sum up, the present disclosure is a method of fabricating fatty acid methyl ester by using Bronsted acid IL, where a Bronsted acid IL is used as a catalyst for fabricating FAME by separating product and the acid IL; and, thus, the catalyst is recyclable and waste acid is reduced.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of fabricating fatty acid methyl ester by using Bronsted acid ionic liquid (IL), comprising steps of:
(a) reacting an organic nitride compound with alkyl sultone to obtain a solid of zwitterion; and, after drying and purifying said zwitterion, processing a reaction with a strong acid having sulfonic group (—SO₃H) to obtain a dense waterproof acidic IL,
wherein a mole ratio of said strong acid to said solid of zwitterion is between 1.0 and 1.5;
(b) adding a hot solution of methanol and fatty acid into said IL to process an esterification,
wherein a mole ratio of said IL to said fatty acid is between 0.01 and 1.0;
wherein a mole ratio of methanol to said fatty acid is between 1 and 30; and
wherein said esterification is processed at a temperature between 25° C. and 120° C. for a period between 0.1 and 10 hours; and
(c) staying still at a high temperature to obtain two layers of materials and obtaining a product being a lighter layer of said layers with said IL being a heavier layer of said layers,
wherein, through the above steps, said Bronsted acid IL is used as a catalyst to obtain said product of fatty acid methyl ester (FAME) by separating said product and said catalyst while said catalyst is reusable.

2. The method according to claim 1,
wherein, in step (c), methanol is removed through vacuuming and water is removed as well to obtain said lighter layer of product with said heavier layer of IL; and
wherein said IL is reusable to re-process said esterification.

3. The method according to claim 1,
wherein said fatty acid is a free fatty acid (FFA) selected from a group consisting of myristic acid, palmitic acid, stearic acid, oleic acid and linoleic acid.

4. The method according to claim 1,
wherein said nitride compound is reacted with an alkyl sultone to obtain said zwitterion used as a precursor of said acidic IL.

5. The method according to claim 4,
wherein said nitride compound is selected from a group consisting of an imidazole compound, a pyridine compound and an alkylamine compound.

6. The method according to claim 4,
wherein said nitride compound is selected from a group consisting of alkylimidazole, alkylpyridine and alkylamine; and
wherein alkyl in said nitride compound is CₘH₂ₘ₊₁, where m=1˜18.

7. The method according to claim 4,
wherein alkyl in said alkyl sultone is CₙH₂ₙ, where n=3˜6.

8. The method according to claim 1,
wherein said strong acid is a Bronsted acid selected from a group consisting of sulfuric acid (H₂SO₄) and alkyl sulfonic acid (R—SO₃H).

9. The method according to claim 8,
wherein said R—SO₃H is selected from a group consisting of fluorosulfonic acid (FSO₃H, FS), trifluoromethanesulfonic acid (CF₃SO₃H, TFMSA) and p-toluene-sulfonic acid (p-CH₃—C₆H₄—SO₃H, P-TSA).

10. The method according to claim 1,
wherein a mole ratio of said strong acid to said zwitterion is preferred between 1.0 and 1.2.

11. The method according to claim 1,
wherein a mole ratio of said IL to said fatty acid is preferred between 0.1 and 0.4.

12. The method according to claim 1,
wherein a mole ratio of methanol to said fatty acid is preferred between 6 and 10.

13. The method according to claim 1,
wherein said temperature of said esterification has a preferred value between 60° C. and 80° C.

14. The method according to claim 1,
wherein said esterification has a preferred period of process time between 2 and 3 hours.
